(19) United States
(12) Patent Application Publication
(10) Pub. No.: US 2019/0152030 A1
(43) Pub. Date: May 23, 2019

(54) Magnetic Tool Connector

(71) Applicant: JEI MOU INDUSTRIAL CO., LTD., Taichung City (TW)

(72) Inventor: Po-Shen Chen, Taichung City (TW)

(21) Appl. No.: 16/254,677

(22) Filed: Jan. 23, 2019

Related U.S. Application Data
(63) Continuation-in-part of application No. 15/661,038, filed on Jul. 27, 2017.

(30) Foreign Application Priority Data
Aug. 18, 2016 (TW) 105126460

(51) Int. Cl. B25B 23/12; B25B 23/00; B25B 13/06

(52) U.S. Cl. CPC B25B 23/12; B25B 13/06; B25B 23/0035

(57) ABSTRACT

A magnetic tool connector includes a main body having a working end. The working end defines first and second chambers in communication each other. The first chamber is configured to receive an object to be driven. The second chamber having a opening at an end edge of the first chamber. The end edge of the first chamber defines an abutting surface for positioning the object within the first chamber. A magnetic assembly is slidably coupled to the main body and includes a magnet. The magnetic assembly is movable between a first position in which the magnet is located outside of the second chamber and a second position in which the magnet is located within the second chamber.

### CROSS-REFERENCE

The present application is a continuation-in-part application of U.S. patent application Ser. No. 15/661,038, now abandoned, filed on Jul. 27, 2017, of which the entire disclosure is incorporated herein.

### FIELD OF THE INVENTION

The present invention relates to a tool connector and, particularly, to a tool connector configured to connect a tool by magnetic attraction.

### BACKGROUND

TW Pat. No. 396182 shows a magnetic tool connector. The magnetic tool connector includes a body having a driven end at one end connectable to a driving tool and a working end connectable to a driven object at another end. The working end includes a magnet assembly configured to magnetically attract the driven object. The working end defines a hole. The magnet assembly includes an end in thread engagement with the hole. The magnet assembly includes a housing and a magnet disposed in the housing. The magnet is located outside of the hole.

When driving the driven object, the magnet is impacted by the driven object. The magnet is also subject to vibrational disturbance. Therefore, the magnet is easily damaged.

The present invention is, therefore, intended to obviate or at least alleviate the problems encountered in the prior art.

### BRIEF SUMMARY

According to the present invention, a magnetic tool connector includes a main body having a first end and a second end and including a working end at the first end. The working end defines first and second chambers in communication each other. The first chamber is configured to receive an object to be driven. The first chamber has a first opening at an end edge of the working end. The second chamber has a second opening at an end edge of the first chamber. The end edge of the first chamber defines an abutting surface for positioning the object within the first chamber. A magnetic assembly is slidably coupled to the main body and includes a magnet configured to magnetically attract the object. The magnetic assembly is movable between a first position in which the magnet is located outside of the second chamber and a second position in which the magnet is located within the second chamber and is prevented from being impacted and damaged by the object. The magnet includes an engaging side configured to abut and magnetically attract the object, and the engaging side is flush with the abutting surface when the magnetic assembly is in the second position.

In an example, the magnetic assembly includes a housing and the magnet is supported by the housing, and the housing is slidably coupled to the main body.

The main body includes a connecting structure and the housing is slidably connected to the connecting structure, and the connecting structure extends within the second chamber.

The connecting structure includes a first shoulder, a guide protrusion, and a second shoulder. The first and second shoulders extend at opposite ends of the guide protrusion. The housing includes a flange at an end engaging the guide protrusion and movably restrained between the first and second shoulders.

The flange extends annularly and has a tab protruding radially inwardly. The tab has a top edge selectively abutting the first shoulder and a bottom edge selectively abutting the second shoulder.

When the magnetic assembly is in the second position, the top edge and the first shoulder are not abutted with one another, and the bottom edge and the second shoulder are abutted with one another.

When the magnetic assembly is in the second position, the top edge and the first shoulder are abutted with one another, and the bottom edge and the second shoulder are not abutted with one another.

The flange includes a first beveled surface extending between the top and bottom edges. The second shoulder includes a second beveled surface, and wherein the housing includes at least one groove extending through inner and outer peripheries thereof.

The second shoulder is disposed in a hole defined by the housing, and the magnet is disposed in the hole.

The main body includes a first structure in a form of a shaft and a second structure in a form of a socket. The shaft includes the guide protrusion and the first and second shoulders at a proximal end thereof and a driven end at a distal end thereof. The second structure defines the first and second chambers and includes a first open end defined by the first opening.

The second structure includes a second open end opposite the first open end and communicating with the second chamber.

The first chamber has a polygonal cross-section. The second chamber has a circular cross-section. A distance between two opposite sides of the first chamber is greater than a diameter of the second chamber.

In another example, the second chamber penetrates through the second end of the main body to form an assembling opening. The magnetic tool connector further includes a connecting member and an elastic member. The connecting member is fixedly coupled to the second chamber via the assembling opening and has a driven end and a supporting end. The elastic member is arranged between the magnetic assembly and the connecting member. Two opposite ends of the elastic member elastically abut against the magnetic assembly and the supporting end respectively.

The magnetic assembly includes a sliding member slidably disposed in the second chamber. The magnet is supported by one end of the sliding member, and the elastic member elastically abuts against the other end of the sliding member.

The second opening is formed as a circular hole with an inner diameter. The sliding member has a first section and a second section. The first and second sections have circular cross-sections. The first section has a first outer diameter, and the second section has a second outer diameter greater than the first outer diameter to form an abutting face between the first and second sections. The inner diameter is less than the second outer diameter but not less than the first outer diameter.

The main body has a shoulder formed between the first and second chambers and selectively abutted against the abutting face. The second opening penetrates through the shoulder.

The first chamber has a polygonal cross-section, and the second chamber has a circular cross-section. The connecting member has a connecting section formed between the driven end and the supporting end, and the connecting section has a polygonal cross-section and is fixedly coupled to the second chamber.

Other objectives, advantages, and new features of the present invention will become apparent from the following detailed description of the invention when considered in conjunction with the accompanied drawings.

### DESCRIPTION OF THE DRAWINGS

The illustrative embodiments may best be described by reference to the accompanying drawings where:

FIG. 1 is a perspective view of a magnetic tool connector of a first embodiment according to the present invention.

FIG. 2 is an exploded, perspective view of the magnetic tool connector of FIG. 1.

FIG. 3 is a cross-sectional view of the magnetic tool connector of FIG. 1.

FIG. 4 is a cross-sectional view showing the magnetic tool connector of FIG. 1 receiving a driven object.

FIG. 5 is a cross-sectional view showing a driving tool driving the driven object through the magnetic tool connector of FIG. 1.

FIG. 6 is a perspective view of a magnetic tool connector of a second embodiment according to the present invention.

FIG. 7 is an exploded, perspective view of the magnetic tool connector of FIG. 6.

FIG. 8 is a cross-sectional view of the magnetic tool connector of FIG. 6.

FIG. 9 is a cross-sectional view showing the magnetic tool connector of FIG. 6 receiving a driven object.

FIG. 10 is a cross-sectional view showing a driving tool driving the driven object through the magnetic tool connector of FIG. 6.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “third”, “fourth”, “bottom”, “side”, “end”, “portion”, “section”, “spacing”, “length”, “depth”, “thickness”, and similar terms are used herein, it should be understood that these terms have reference only to the structure shown in the drawings as it would appear to a person viewing the drawings and are utilized only to facilitate describing the illustrative embodiments.

### DETAILED DESCRIPTION

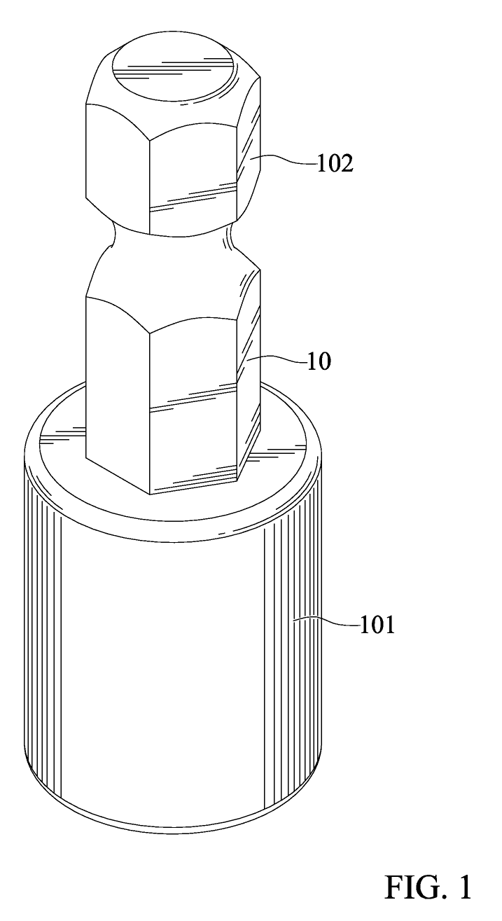

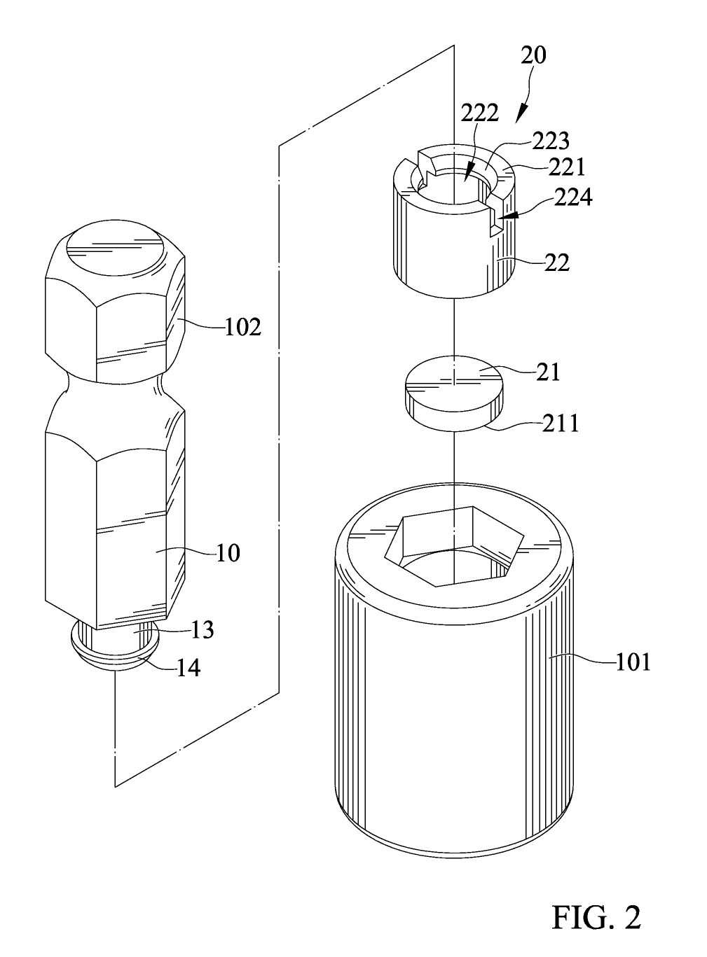

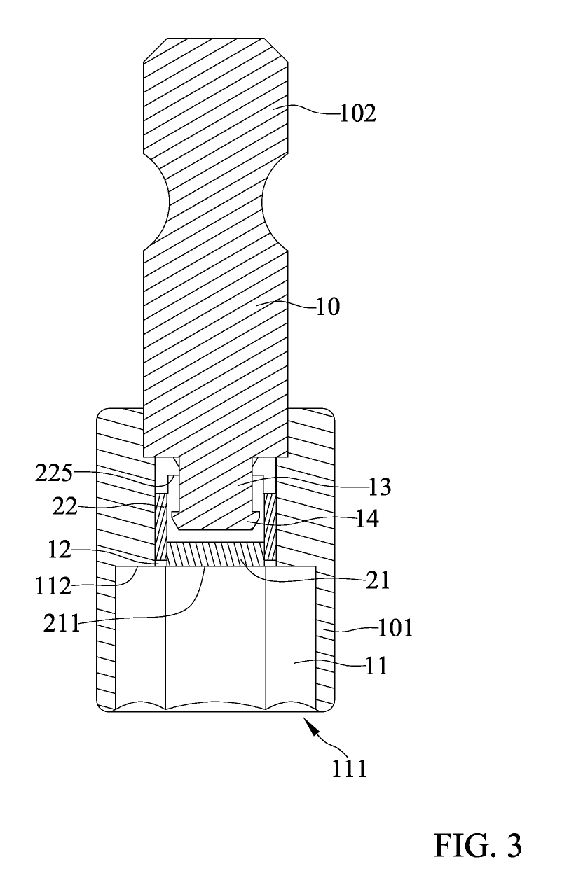

FIGS. 1-5 show a magnetic tool connector of a first embodiment according to the present invention. A main body 10 has a first end 101 and a second end 102 and includes a working end at the first end 101 and a driven end at the second end 102 respectively. The working end defines a first and second chamber 11 and 12. The first chamber 11 is configured to receive an object P to be driven. The first chamber 11 has a first opening 111 at an end edge of the working end. The second chamber 12 has a second opening 121 at an end edge of the first chamber 11. The end edge of the first chamber 11 defines an abutting surface 112 for positioning the object P within the first chamber 11. The first chamber 11 has a polygonal cross-section. The second chamber 12 has a circular cross-section. A distance between two opposite sides of the first chamber 11 is greater than a diameter of the second chamber 12. The first chamber 11 has a hexagonal cross-section. The housing 22 has a circular cross-section.

A magnetic assembly 20 is slidably coupled to the main body 10. The magnetic assembly 20 includes a magnet 21 configured to magnetically attract the object P and a housing 22 supporting the magnet 21. The main body 10 includes a connecting structure and the housing 22 is slidably connected to the connecting structure. The connecting structure extends within the second chamber 12. The connecting structure includes a first shoulder 122, a guide protrusion 13, and a second shoulder 14. The first and second shoulders 122 and 14 extend at opposite ends of the guide protrusion 13. The first and second shoulders 122 and 14 extend radially outwardly from the guide protrusion 13. The second shoulder 14 is disposed in a hole 222 defined by the housing 22. The second should 14 inserts in the housing 22 through the hole 222. The magnet 21 is disposed in the hole 222. The housing 22 includes a flange 223 at an end engaging the guide protrusion 13 and movably restrained between the first and second shoulders 122 and 14. The flange 223 extends annularly and has a tab protruding radially inwardly.

The main body 10 includes a first structure in a form of a shaft and a second structure in a form of a socket. The shaft includes the guide protrusion 13 and the first and second shoulders 122 and 14 at a proximal end thereof and the driven end at a distal end thereof The second structure defines the first and second chambers 11 and 12 and includes a first open end defined by the first opening 111. The second structure includes a second open end opposite the first open end and communicating with the second chamber 12. The guide protrusion 13 and the first and second shoulders 122 and 14 are inserted through the second open end into the second chamber 12. The shaft and the socket are not free to move with respect to each other. The shaft and socket are in tight engagement with one another.

The magnetic assembly 20 is movable between a first position in which the magnet 21 is located outside of the second chamber 12 and a second position in which the magnet 21 is located within the second chamber 12 and is prevented from being impacted and damaged by the object P. The magnet 21 includes an engaging side 211 configured to abut and magnetically attract the object P. The engaging side 211 is flush with the abutting surface 112 when the magnetic assembly 20 is in the second position. The engaging side 211 of the magnet 21 is not flush with the abutting surface 112 when the magnetic assembly 20 is in the first position. The engaging side 211 of the magnet 21 and the abutting surface 112 are aligned with an axis A when the magnetic assembly 20 is in the second position. Furthermore, the tab of the flange 223 has a top edge 221 selectively abutting the first shoulder 122 and a bottom edge 225 selectively abutting the second shoulder 14. When the magnetic assembly 20 is in the second position, the top edge 221 and the first shoulder 122 are not abutted with one another, and the bottom edge 225 and the second shoulder 14 are abutted with one another. When the magnetic assembly 20 is in the second position, the top edge 221 and the first shoulder 122 are abutted with one another, and the bottom edge 225 and the second shoulder 14 are not abutted with one another. In addition, the top edge 221 defines the top surface of the housing 22.

The flange 223 includes a first beveled surface extending between the top and bottom edges 221 and 225. The second shoulder 14 includes a second beveled surface. The housing 22 includes at least one groove 224 extending through inner and outer peripheries thereof. The at least one groove 224 extends radially from the hole 222. The first beveled surface facing inwardly. The second beveled surface facing outwardly. The at least one groove 224 facilitates deflection of the flange 223. The first and second beveled surfaces and the at least one groove 224 facilitate engagement of the housing 22 with the guide protrusion 13.

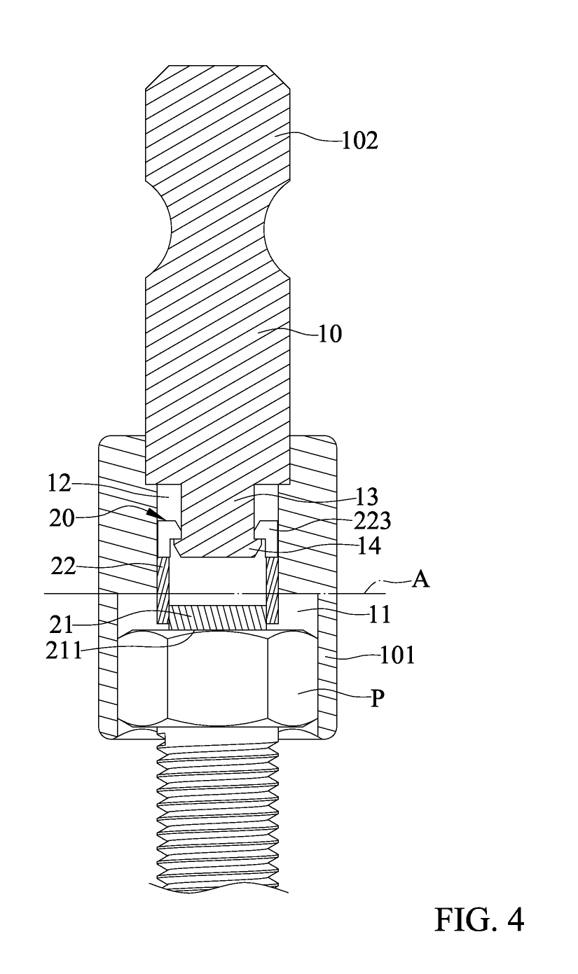

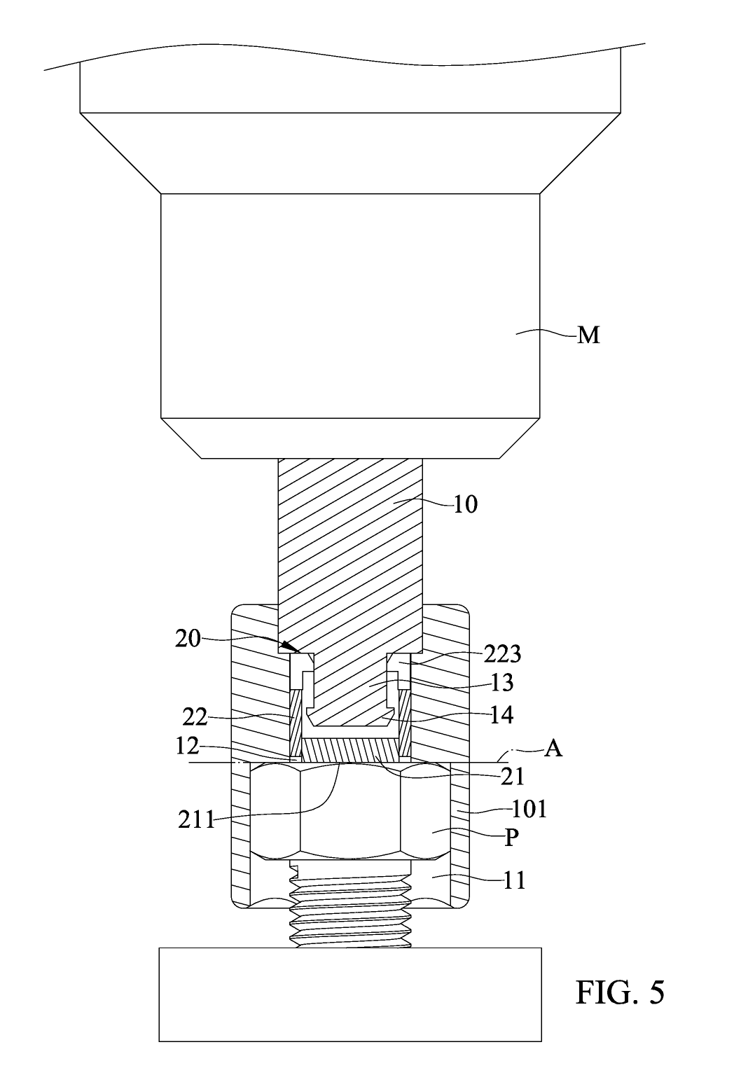

FIG. 4 shows the object P to be driven is disposed in the first chamber 11, and the magnetic assembly 20 is in the first position. FIG. 5 shows a driving tool M can engage the driven end to drive the magnetic tool connector. When the object P is driven into another object, the object P is rest on the abutting surface 112, and the magnetic assembly 20 is moved to the second position.

In view of the forgoing, the magnet 21 is located within the second chamber 12 when the magnetic assembly 20 is in the second position, the engaging side 211 of the magnet 21 and the abutting surface 112 are flush with one another and are aligned with the axis A, and the abutting surface 112 prevents the object P from impacting the magnet 21. Therefore, the magnet 21 is not impacted and damaged by the object P.

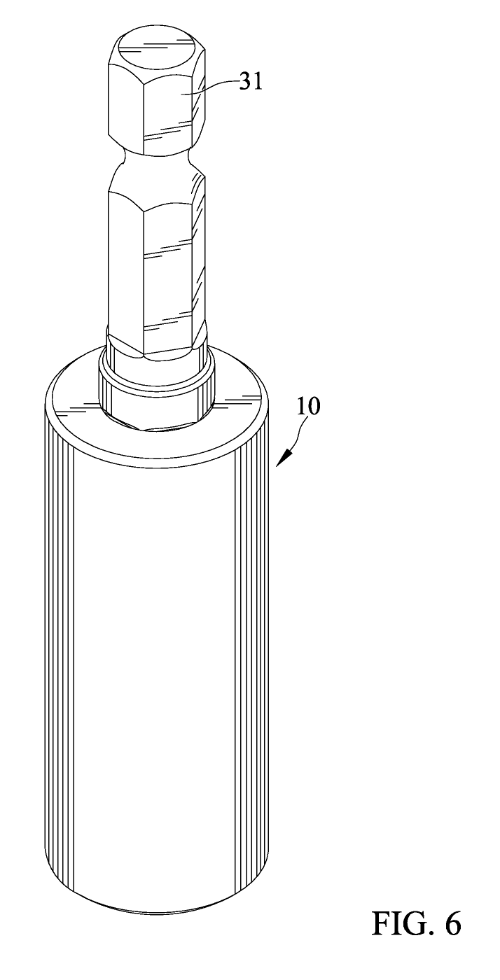

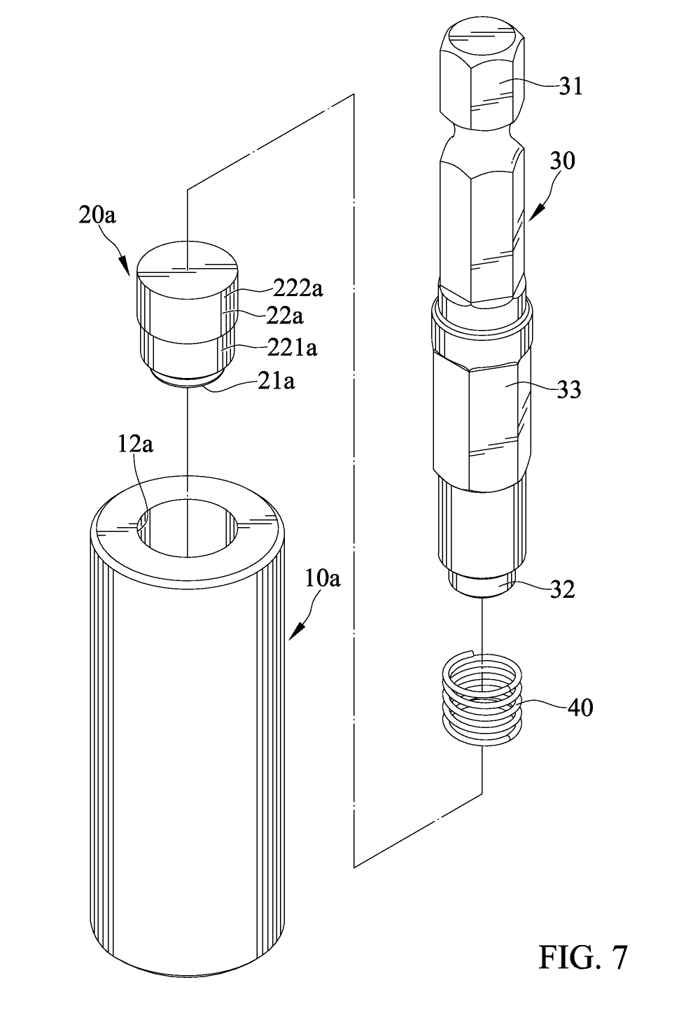

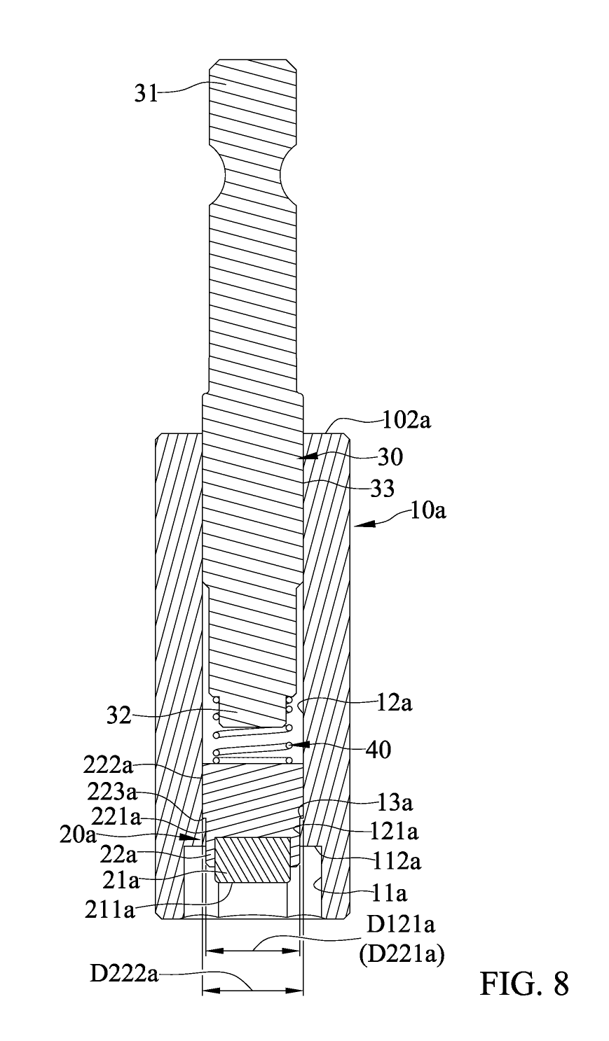

FIGS. 6-10 show a magnetic tool connector of a second embodiment according to the present invention. The second embodiment is substantially the same as the first embodiment except that the second chamber 12a penetrates through the second end 102a of the main body 10a to form an assembling opening at the second end 102a. The magnetic tool connector of the second embodiment further includes a connecting member 30 and an elastic member 40.

The connecting member 30 is fixedly coupled to the second chamber 12a via the assembling opening and has a driven end 31 and a supporting end 32. Further, the first chamber 11a has a polygonal cross-section, and the second chamber 12a has a circular cross-section. The connecting member 30 has a connecting section 33 formed between the driven end 31 and the supporting end 32. The connecting section 33 has a polygonal cross-section and is fixedly coupled to the second chamber 12a, so as to allow the connecting member 30 and the elastic member 40 to be assembled sequentially with respect to the second chamber 12a. Thus, the magnetic tool connector of the second embodiment can easily be assembled.

The elastic member 40 is arranged between the magnetic assembly 20a and the connecting member 30. Two opposite ends of the elastic member 40 elastically abut against the magnetic assembly 20a and the supporting end 32, respectively.

The magnetic assembly 20a includes a sliding member 22a slidably disposed in the second chamber 12a. The magnet 21a is supported by one end of the sliding member 22a, and the elastic member 40 elastically abuts against the other end of the sliding member 22a. Thus, the elastic member 40 may be a compression spring for biasing the sliding member 22a.

The second opening 121a is formed as a circular hole with an inner diameter D121a. The sliding member 22a has a first section 221a and a second section 222a integrally formed therein. Both of the first and second sections 221a and 222a have circular cross-sections. Further, the first section 221a has a first outer diameter D221a, and the second section 222a has a second outer diameter D222a greater than the first outer diameter D221a to form an abutting face 223a between the first and second sections 221a and 222a. The inner diameter D121a is less than the second outer diameter D222a but not less than the first outer diameter D221a to prevent the sliding member 22a falls out of the second chamber 12a.

The main body 10a has a shoulder 13a formed between the first and second chambers 11a and 12a and selectively abutted against the abutting face 223a to limit the sliding member 22a. The second opening 121a penetrates through the shoulder 13a to cause the first and second chambers 11a and 12a in communication each other.

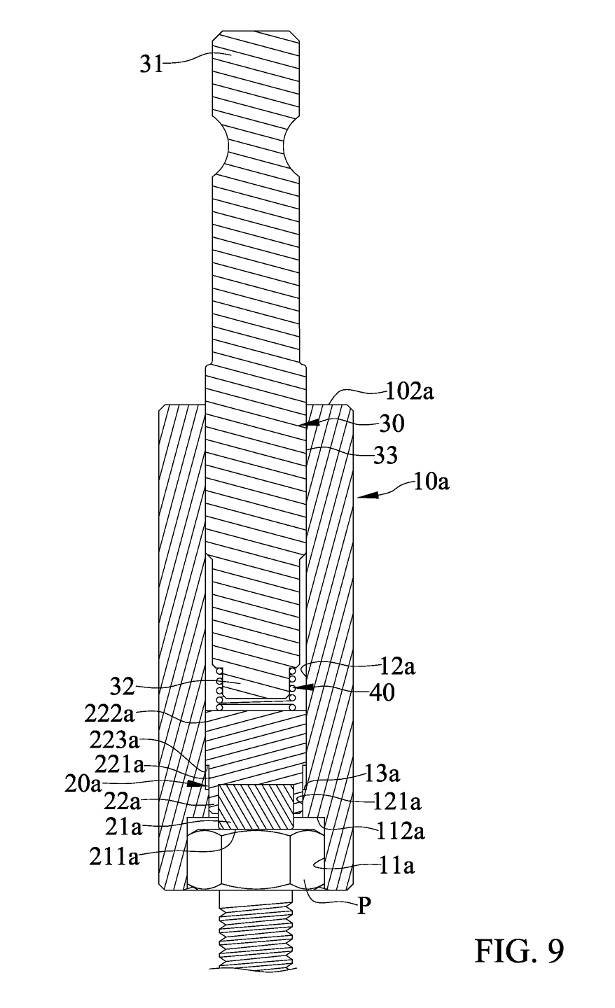

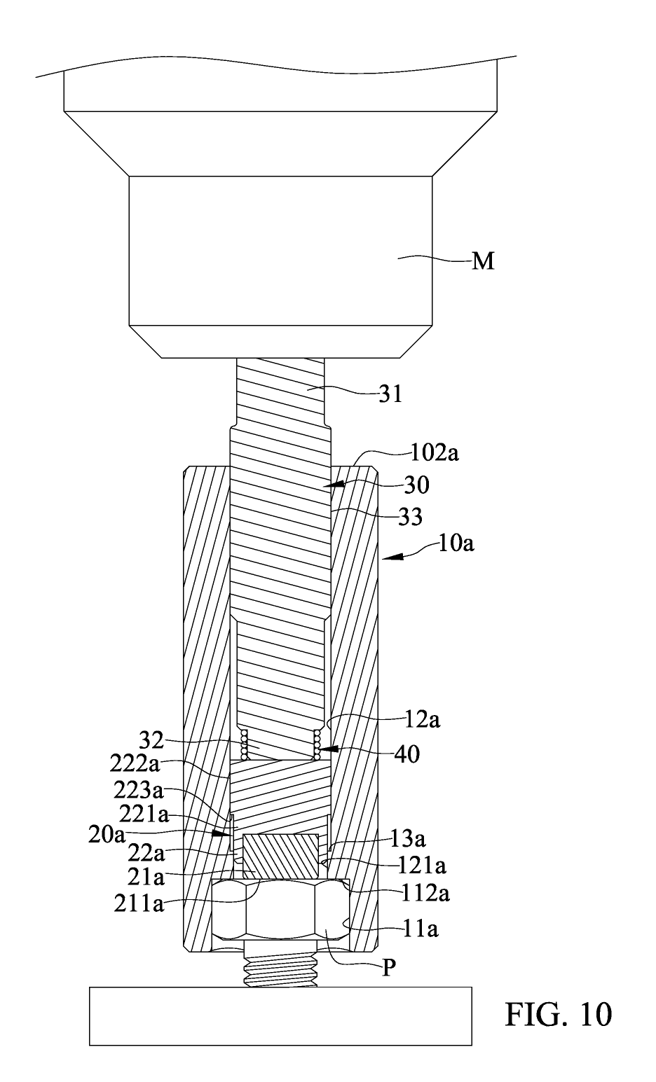

FIG. 9 shows the object P to be driven is disposed in the first chamber 11a, and the magnetic assembly 20a is in the first position. FIG. 10 shows a driving tool M can engage the driven end 31 to drive the magnetic tool connector. When the object P is driven into another object, the object P is rest on the abutting surface 112a, and the magnetic assembly 20a is moved to the second position.

In view of the forgoing, the magnet 21a is located within the second chamber 12a when the magnetic assembly 20a is in the second position, the engaging side 211a of the magnet 21a and the abutting surface 112a are flush with one another and are aligned with the axis, and the abutting surface 112a prevents the object P from impacting the magnet 21a. Therefore, the magnet 21a is not impacted and damaged by the object P.

The foregoing is merely illustrative of the principles of this invention, and various modifications can be made by those skilled in the art without departing from the scope and spirit of the invention.

1. A magnetic tool connector comprising:
a main body having a first end and a second end and including a working end at the first end, with the working end defining first and second chambers in communication each other, with the first chamber configured to receive an object to be driven, with the first chamber having a first opening at an end edge of the working end, with the second chamber having a second opening at an end edge of the first chamber, and with the end edge of the first chamber defining an abutting surface for positioning the object within the first chamber; and
a magnetic assembly slidably coupled to the main body and including a magnet configured to magnetically attract the object, wherein the magnetic assembly is movable between a first position in which the magnet is located outside of the second chamber and a second position in which the magnet is located within the second chamber and is prevented from being impacted and damaged by the object, wherein the magnet includes an engaging side configured to abut and magnetically attract the object, and wherein the engaging side is flush with the abutting surface when the magnetic assembly is in the second position.

2. The magnetic tool connector as claimed in claim 1, wherein the magnetic assembly includes a housing and the magnet is supported by the housing, and wherein the housing is slidably coupled to the main body.

3. The magnetic tool connector as claimed in claim 2, wherein the main body includes a connecting structure and the housing is slidably connected to the connecting structure, and wherein the connecting structure extends within the second chamber.

4. The magnetic tool connector as claimed in claim 3, wherein the connecting structure includes a first shoulder, a guide protrusion, and a second shoulder, with the first and second shoulders extending at opposite ends of the guide protrusion, and wherein the housing includes a flange at an end engaging the guide protrusion and movably restrained between the first and second shoulders.

5. The magnetic tool connector as claimed in claim 4, wherein the flange extends annularly and has a tab protruding radially inwardly, and wherein the tab has a top edge selectively abutting the first shoulder and a bottom edge selectively abutting the second shoulder, wherein when the magnetic assembly is in the second position, the top edge and the first shoulder are not abutted with one another, and the bottom edge and the second shoulder are abutted with one another, and wherein when the magnetic assembly is in the second position, the top edge and the first shoulder are abutted with one another, and the bottom edge and the second shoulder are not abutted with one another.

6. The magnetic tool connector as claimed in claim 5, wherein the flange includes a first beveled surface extending between the top and bottom edges, wherein the second shoulder includes a second beveled surface, and wherein the housing includes at least one groove extending through inner and outer peripheries thereof.

7. The magnetic tool connector as claimed in claim 6, wherein the second shoulder is disposed in a hole defined by the housing, and wherein the magnet is disposed in the hole.

8. The magnetic tool connector as claimed in claim 4, wherein the main body includes a first structure in a form of a shaft and a second structure in a form of a socket, wherein the shaft includes the guide protrusion and the first and second shoulders at a proximal end thereof and a driven end at a distal end thereof, and wherein the second structure defines the first and second chambers and includes a first open end defined by the first opening.

9. The magnetic tool connector as claimed in claim 8, wherein the second structure includes a second open end opposite the first open end and communicating with the second chamber.

10. The magnetic tool connector as claimed in claim 1, wherein the first chamber has a polygonal cross-section, wherein the second chamber has a circular cross-section, and wherein a distance between two opposite sides of the first chamber is greater than a diameter of the second chamber.

11. The magnetic tool connector as claimed in claim 1, wherein the second chamber penetrates through the second end of the main body to form an assembling opening;
wherein the magnetic tool connector further comprising:
a connecting member fixedly coupled to the second chamber via the assembling opening and having a driven end and a supporting end; and
an elastic member arranged between the magnetic assembly and the connecting member, with two opposite ends of the elastic member elastically abutting against the magnetic assembly and the supporting end respectively.

12. The magnetic tool connector as claimed in claim 11, wherein the magnetic assembly includes a sliding member slidably disposed in the second chamber, wherein the magnet is supported by one end of the sliding member, and wherein the elastic member elastically abuts against the other end of the sliding member.

13. The magnetic tool connector as claimed in claim 12, wherein the second opening is formed as a circular hole with an inner diameter, wherein the sliding member has a first section and a second section, with the first and second sections have circular cross-sections, with the first section having a first outer diameter, and with the second section having a second outer diameter greater than the first outer diameter to form an abutting face between the first and second sections, and wherein the inner diameter is less than the second outer diameter but not less than the first outer diameter.

14. The magnetic tool connector as claimed in claim 13, wherein the main body has a shoulder formed between the first and second chambers and selectively abutted against the abutting face, and wherein the second opening penetrates through the shoulder.

15. The magnetic tool connector as claimed in claim 11, wherein the first chamber has a polygonal cross-section, wherein the second chamber has a circular cross-section, wherein the connecting member has a connecting section formed between the driven end and the supporting end, and wherein the connecting section has a polygonal cross-section and is fixedly coupled to the second chamber.
